(19) United States
(12) Patent Application Publication
(10) Pub. No.: US 2011/0090050 A1
(43) Pub. Date: Apr. 21, 2011

(54) METHOD FOR LOCATING OBJECTS

(75) Inventor: Hector Gómez MACFARLAND, Cedar Park, TX (US)

(73) Assignee: RFID MEXICO, S.A. DE C.V., San Pedro Garza Garcia (MX)

(21) Appl. No.: 12/580,047

(22) Filed: Oct. 15, 2009

(51) Int. Cl. G06K 7/01; G01D 21/00; C09K 11/06; G08B 5/22

(52) U.S. Cl. 340/8.1; 116/201; 252/301.35

(57) ABSTRACT

A method for locating objects including: applying an adherent composition to the object, the composition including an adherent substance, a fluorescent substance and an odorific substance; and visually locating the object by the light emitted by the fluorescent substance or by the odor given off by the odorific substance which may be detected by a specially trained animal.

### BACKGROUND OF THE INVENTION

A. Field of the Invention.

The present invention is related to methods for locating objects and more particularly to a method for locating objects comprising: applying an adherent composition to the object, said composition including an adherent substance, a fluorescent substance and an odorific substance; and visually locating said object by means of the light emitted by said fluorescent substance or by the odor given off by the odorific substance which may be detected by an specially trained animal.

B. Description of the Related Art.

There are several methods and systems for locating objects based on RFID, GPS and other related technologies, which are very reliable and exact. However there are times when an object can not be located, either because it is out of range of said systems or because the electronic chip (in an RFID based located system) fails.

In such cases, it is very difficult to locate said object if the object has little or no visual aids.

The above problem becomes very delicate in industrial or medical environments wherein losing and object could be very problematic or even dangerous.

Therefore, it would be desirable to be able to easily and readily locate lost objects controlled by electronic locating systems when said systems fails.

In view of the above referred problem, applicant developed a method for locating objects which comprises applying an adherent composition to the object, said composition including an adherent substance. a fluorescent substance and an odorific substance; and visually locating said object by means of the light emitted by said fluorescent substance or by the odor given off by the odorific substance which may be detected by an specially trained animal.

The method of the present invention may be used in combination with item localization systems using RFID technology, wherein the RFID chips correspondent to each item tracked by the system, may be glued to each item using the adherent composition of the method of the present invention, thus obtaining the same results as when the adherent composition is applied to any external surface of the object.

There are several prior art documents disclosing adherent substances and resins including either a fluorescent compound or an odorific substance or both.

For example, EP patent No. EP0410248 (A2) discloses a multilayered, flexible marking tape comprising an auxiliary support and a contact-adhesive layer. The contact-adhesive layer may be coloured with fluorescent pigments, thus marking tape becomes highly suitable for marking or highlighting passages in written text.

Patent No. GB1482459 (A), discloses a liquid non-aqueous air-stable anaerobic curing composition which additionally may comprise material selected from ethylenically-unsaturated non-acrylic monomers, alkanols or mercaptans, plasticizers, stabilizers, polymeric thickeners, inorganic thickeners, inorganic and organic fillers, and visible and ultraviolet fluorescent dyes.

Japanese patent No. JP4180980 (A) discloses an adhesive having a fluorescent material incorporated therein which is used to bond and fix a circuit board to the case. The adhesive enables visual inspection of the adhesion thereof to a hydrid IC, an individual element, the terminal of the case, etc., when cured by irradiation with ultraviolet rays. Therefore, the adhesive makes it possible to simplify the removal of adhesive as compared with conventional adhesives the removal of which is carried out for all wire bonding parts regardless of the presence or absence of an adherent adhesive, and it can also improve the reliability of wire bonding in respect of initial strength, etc.

Japanese patent No. JP2004244585 (A) discloses an acrylic adhesive composition containing an acrylic polymer, the tackifier and a fluorescent brightening agent. Preferably, the tackifier is a rosin-based resin, terpene-based resin or petroleum resin. Also preferably, the fluorescent brightening agent is an oxazole-based or a coumarin-based fluorescent brightening agent.

U.S. Pat. No. 6,204,309 discloses a cyanoacrylate adhesive containing a pyrylium salt as a fluorescent dye are useful for bonding various substrates, particularly transparent plastics. The pyrylium salt may be present in relatively large quantities in the adhesive without any adverse effect on the storage stability and adhesive properties, yet shows very little inherent coloration in visible light.

U.S. Pat. No. 6,461,326 discloses an intraluminal medical device comprised of two or more substrates formed of the same or a different material wherein the substrates are bonded together using a fluorescent dyed adhesive. The fluorescent adhesive allows for easy and non-destructive inspection of the bond quality, as well as allowing easy determination of imperfections or tears in the balloon material.

U.S. Pat. No. 7,059,760 discloses a method and apparatus for post mixing an additive with a hot melt adhesives, said additive is preferably selected from wetness indicators, antimicrobial agents, pigments, dyes, ultraviolet light absorbers, antioxidants, fluorescent agents, pH indicators and fragrances.

Although the above referred patents disclose the use of adherent substances including either a fluorescent substance, an odorific substance or both, none disclose or even suggest that such substances may be used in a method similar to applicants method.

### SUMMARY OF THE INVENTION

It is therefore a main object of the present invention to provide a method for locating objects comprising: applying an adherent composition to the object, said composition including an adherent substance, a fluorescent substance and an odorific substance; and visually locating said object by means of the light emitted by said fluorescent substance or by the odor given off by the odorific substance.

It is another main object of the present invention to provide a method for locating objects of the above referred nature in which the odorific substance may be detected by an specially trained animal.

Its is a further object of the present invention to provide a method for locating objects which may be used in combination with item localization systems using RFID technology, wherein the RFID chips correspondent to each item tracked by the system, may be glued to each item using the adherent composition of the method of the present invention, thus obtaining the same results as when the adherent compound is applied to any external surface of the object.

These and other objects and advantages of the method for locating objects of the present invention of the present invention will become apparent to those persons having an ordinary skill in the art, from the following detailed description of the embodiments of the invention, which will be made with reference to the accompanying drawings.

### DETAILED DESCRIPTION OF THE INVENTION

The method for locating objects of the present invention will be described in accordance with a preferred embodiment thereof. In a preferred embodiment, the method is used in combination with an item control system using RFID technology for locating a plurality of items, wherein each item includes a RFID chip and wherein the method for locating objects of the present invention comprising:

applying an adherent composition to each item, said substance comprising:
an adherent substance comprising an epoxy resin;
a fluorescent substance comprising an urethane pigment for epoxy resins having a fluorescent color; and
an odorific substance comprising a pure natural scent;

visually locating said items by means of the light emitted by said fluorescent substance; and/or

locating said items by the odor given off by the odorific substance which may be detected by an specially trained animal.

The odorific substance may comprise any natural scent and in other embodiments of the invention may comprise any synthetic scent designed to be detected by specially trained animals.

Additionally, it has to be understood that the fluorescent substance may be comprised by any known fluorescent pigment that can be readily mixed with the resin and the odorific substance.

The adherent composition may be applied to any visible surface of the item.

In other embodiments of the invention, the items may be classified by the item control system by specific characteristics, and in order to help locating the objects by their classification if the item control system fails, the method of the present invention may comprise further applying different adherent compositions having specific odorific substances and/or a fluorescent pigments having specific colors to each group of items, so that each group of items have a specific color and/or scent in order to classify said objects in accordance to their odor and/or scent corresponding to their classification.

In yet another embodiment of the present invention, the adherent composition may be used to attach the RFID chips to any visible surface of each item, so that the light emitted by the fluorescent substance can be seen from below or the sides of the RFID chip and the odor given of by the odorific substance can be detected.

Finally it must be understood that the method for locating objects of the present invention, is not limited exclusively to the embodiments above described and illustrated and that the persons having ordinary skill in the art can, with the teaching provided by the invention, to make modifications to the method for locating objects of the present invention, which will clearly be within of the true inventive concept and of the scope of the invention which is claimed in the following claims.

What is claimed is:

1. A method for locating a plurality of items comprising:
applying an adherent composition to each item, said composition comprising:
an adherent substance;
a fluorescent substance; and
an odorific substance;
visually locating said items by means of the light emitted by said fluorescent substance; and/or
locating said items by the odor given off by the odorific substance.

2. A method for locating a plurality of items in accordance with claim 1, wherein the adherent substance comprises an epoxy resin.

3. A method for locating a plurality of items in accordance with claim 1, wherein the fluorescent substance comprises an urethane pigment for epoxy resins having a fluorescent color.

4. A method for locating a plurality of items in accordance with claim 1, wherein the odorific substance comprising a pure natural scent.

5. A method for locating a plurality of items in accordance with claim 1, wherein the odorific substance comprising a synthetic scent.

6. A method for locating a plurality of items in accordance with claim 1, wherein the odor given of by the odorific substance is detected by an specially trained animal.

7. A method for locating a plurality of items in accordance with claim 1, wherein the items are classified in more than one category and wherein the method further comprising:
providing more than one adherent compounds, each having a different fluorescent color and/or odor;
applying said more than one adherent compounds having the same color and/odor to the items having the same category;
visually locating said items by means of the light emitted by said fluorescent substance and grouping the items having the same color; and/or
locating said items by the odor given off by the odorific substance and grouping the items having the same odor.

8. A method for locating a plurality of items in accordance with claim 1 used in combination with an item control system using RFID technology for locating a plurality of items, wherein each item includes a RFID chip, wherein the method further comprising attaching a RFID chip to each item by means of said adherent substance so that the light emitted by the fluorescent substance can be seen from below or the sides of the RFID chip and the odor given of by the odorific substance can be detected.

9. An adherent composition comprising:
an adherent substance;
a fluorescent substance; and
an odorific substance.

10. An adherent composition as claimed in claim 9, wherein the adherent substance comprises an epoxy resin.

11. An adherent composition as claimed in claim 9, wherein the fluorescent substance comprises an urethane pigment for epoxy resins having a fluorescent color.

12. An adherent composition as claimed in claim 9, wherein the odorific substance comprising a pure natural scent.

13. An adherent composition as claimed in claim 9, wherein the odorific substance comprising a synthetic scent.
